(19) United States
(12) Patent Application Publication
(10) Pub. No.: US 2014/0150329 A1
(43) Pub. Date: Jun. 5, 2014

(54) Fishing Lure

(71) Applicant: David Waldroup, San Antonio, TX (US)

(72) Inventor: David Waldroup, San Antonio, TX (US)

(21) Appl. No.: 13/935,804

(22) Filed: Jul. 5, 2013

Related U.S. Application Data
(60) Provisional application No. 61/732,197, filed on Nov. 30, 2012.

(51) Int. Cl. A01K 85/14

(52) U.S. Cl. CPC A01K 85/14
USPC 43/42.25; 43/42.5; 43/42.51; 43/42.32

(57) ABSTRACT

A fishing lure is disclosed comprising a lure body comprising a concave surface, and first and second slots defined in the lure body, wherein the first slot and the second slot are configured so that, when a fishing hook is placed through both of them, the fishing hook will be held in a position with the barb extending from the lure body. In certain embodiments the lure can be decorated with decals and provided with a variety of optional features.

### PRIORITY CLAIMS

This application claims priority to U.S. Provisional Application No. 61/732,197, filed Nov. 30, 2012, which is hereby incorporated by reference.

### BACKGROUND

Angling, or rod and reel fishing, is an extremely popular recreational pastime. Fishermen use a wide variety of equipment in attempts to catch more, larger, or specific fish. One important piece of fishing equipment is a lure. Many types of fishing lures are known and have been used.

One popular type of lure is a spoon lure. Spoon lures typically comprise a metal spoon-shaped body, with one or more hooks attached at a trailing end or welded or soldered to the concave portion. Spoon lures can be configured to move in seemingly random patterns in water, giving a life-like appearance. Spoon lures are also relatively easy to manufacture and, properly configured, are less likely than other types to become entangled on weeds and other underwater obstructions.

However, spoon lures in the prior art suffer from several drawbacks. First, since they are typically made with smooth edges, they may not provide a realistic mouth feel for the targeted game fish. Additionally, hooks are often permanently attached to spoon lures, preventing replacement if the hook is damaged or if an alternative hook type is desired. Further, existing spoon lures have a static metallic color which is not always ideal in all angling situations.

### SUMMARY

Limitations in the prior are solved by the disclosed fishing lures such as a lure body with a concave surface, and first and second slots defined in the lure body, wherein the first slot and the second slot are configured so that, when a fishing hook is placed through both of them, the fishing hook will be held in a position with the barb extending from the lure body in predetermined relationship. In one embodiment, the slots are configured to hold the fishing hook so that it extends from the lure body at an angle between 80 and 100 degrees with respect to a line tangent lure body between the first and second slot.

In certain embodiments the lure can be decorated with decals for aesthetic, marketing, or enhanced realism purposes.

Other embodiments utilize leader attachments with buzz blades, spinner blades, or other devices.

Additional embodiments further comprise a trailing hook attached to the fishing hook.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 is a perspective view of a fishing lure.

FIGS. 2A and 2B are perspective views of alternative embodiments of fishing lures.

FIGS. 3A and 3B are perspective views of additional embodiments of a fishing lure.

FIGS. 4A and 4B illustrate decoration of a fishing lure using a decal.

FIG. 5A is a partial section view of the fishing lure of FIG. 1.

FIG. 5B is a partial section view of a fishing lure with a weed guard and other features.

FIG. 6 is a perspective view of a fishing lure with an optional spinner-bait attachment.

### DETAILED DESCRIPTION

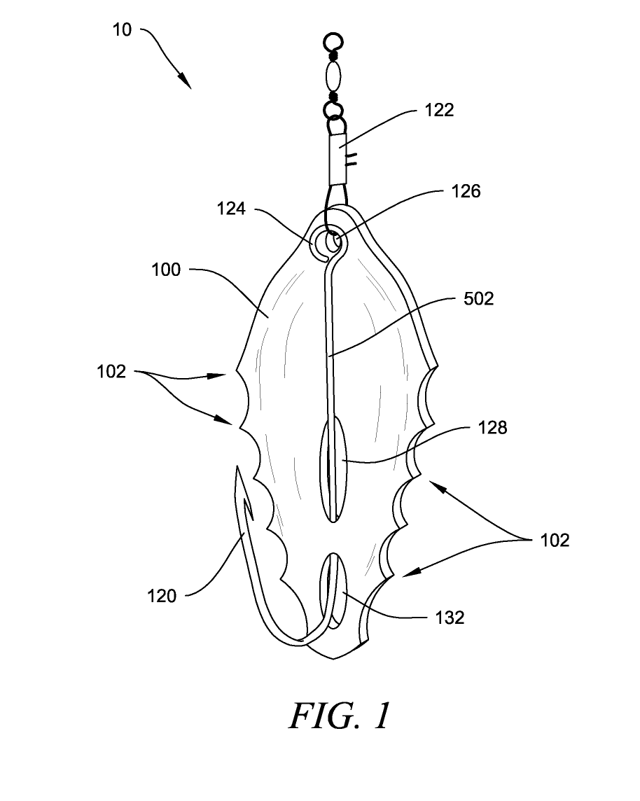

FIG. 1 illustrates a fishing lure 10 embodying features of certain disclosed inventions. Fishing lure 10 preferably comprises a lure body 100. Lure body 100 is preferably concave and generally elliptical in shape. Lure body 100 preferably comprises serrated teeth 102 along at least part of its edge. Lure body 100 is preferably constructed of a strong and corrosion-resistant material, such as stainless steel.

Fishing lure 10 also comprises a hook 120. Hook 120 is preferably attached to lure body 100 by a clip 122 secured through an eye 124 defined in hook 120 and through a hole 126 defined in lure body 100. Hook 120 also preferably extends through forward slot 128 and trailing slot 132, defined in lure body 100. Forward slot 128 and trailing slot 132 are preferably configured such that, when hook 120 is secured by clip 122 and extends through lure body 100, hook 120 remains held in a relatively fixed position with respect to lure body 100. Hook 120 can be replaced by a user if hook 120 is damaged or if a different hook type 120 is desired, i.e.; switching from freshwater to saltwater angling. Hook 120 can also be replaced if user desires a different color or style of skirt 220.

Applicant has found that Mustad Ref# 3407SSD Hook Size 8/0 (Saltwater) and Mustad Ref# 3407DT Hook Size 8/0 (Freshwater) are well-suited for use with lure 10. However, many other hooks can be used, provided forward slot 128 and trailing slot 132 are sized and positioned appropriately.

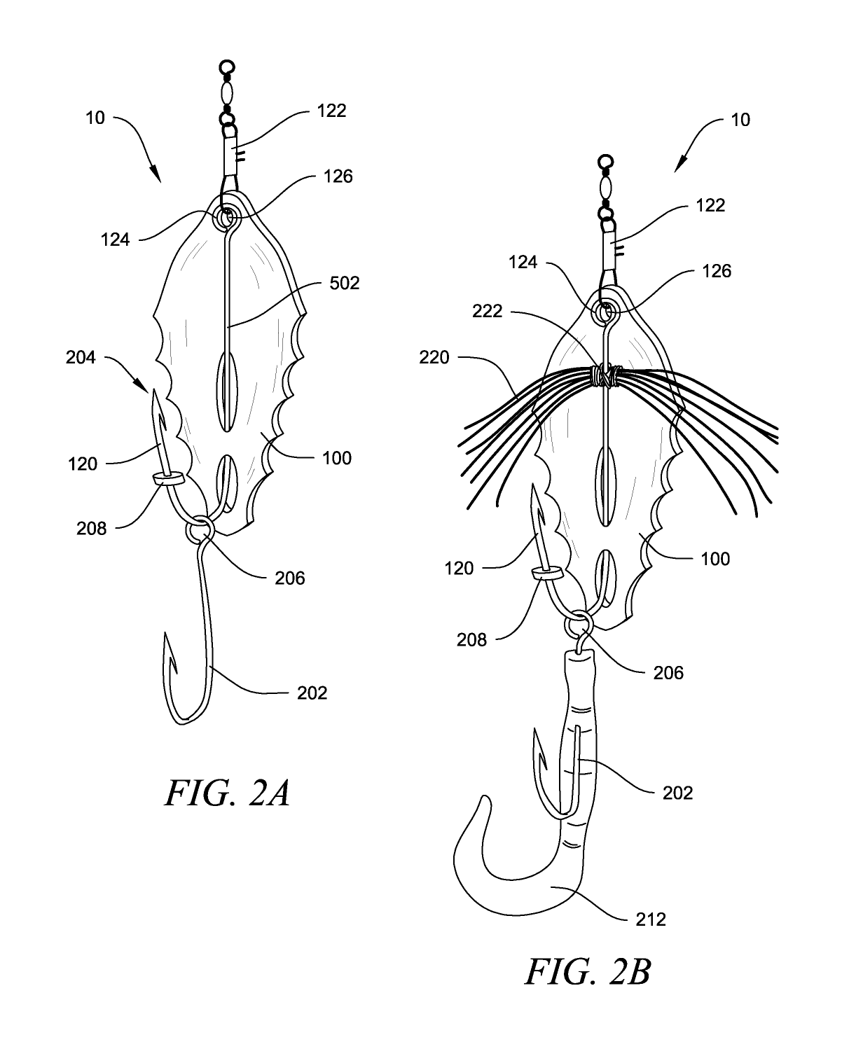

FIG. 2A illustrates a fishing lure 10 with additional optional features. A trailing hook 202 is shown attached to hook 120. Trailing hook 202 is attached by inserting barbed end 204 of hook 120 through an eye 206 in trailing hook 202. Preferably, a retaining ring 208 is placed on hook 120 to prevent trailing hook 202 from accidentally disengaging hook 120. A supplemental lure 212 can be optionally threaded onto trailing hook 202, as illustrated in FIG. 2B.

FIG. 2B shows a skirt 220 attached to hook 120. Skirt 220 comprises rubber strands and is preferably colored and decorated to attract fish. Skirt 220 is preferably attached to hook 120 using Kevlar string 222, which is wound around skirt 220 then glued in place with superglue, epoxy, or other adhesive. Other configurations (not shown) for skirt 220 could be used, such as rubber strands secured parallel to hook 120, extending forward, backward, or both. In yet another alternative configuration, rubber strands can be glued to a rubber ring (not shown), which is slid onto hook 120. FIG. 2B also shows optional artificial bait 212 positioned on trailing hook 202. Artificial bait 212 can conceal part of trailing hook 202 and make lure 10 more realistic.

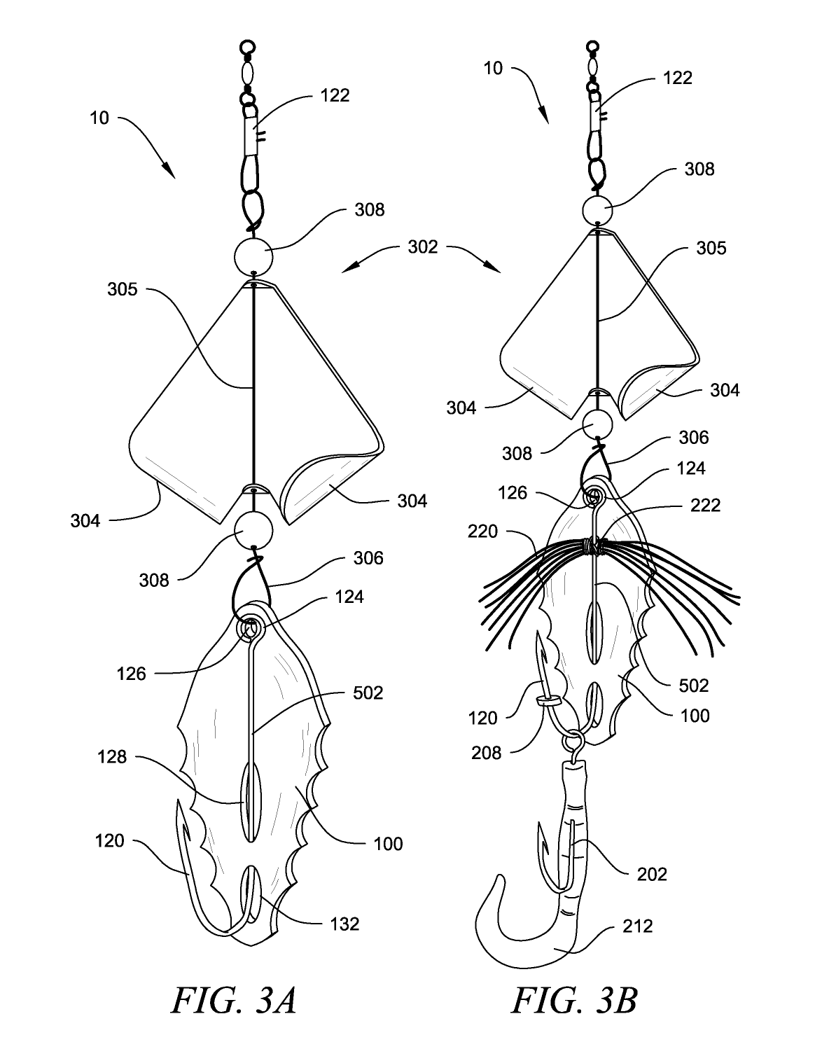

FIG. 3A illustrates a fishing lure 10 with an optional buzz blade 302. Buzz blade 302 is shown as a metal blade with two wings 304. Rearward portions of each wing 304 are inclined in opposing orientations so that buzz blade 302 will tend to rotate as it moves through water. Alternatively, buzz blade 302 could comprise three or more wings and could be made with various metallic surfaces and/or various color patterns of the users choosing. Buzz blade 302 is rotatably mounted to wire 305 and is attached to lure body 100 by a loop 306 formed in wire 305 through hole 126. Beads 308 are placed on wire 305 above and below buzz blade 302 to facilitate spinning.

FIG. 3B is a fishing lure 10 with buzz blade 302 and trailing hook 202.

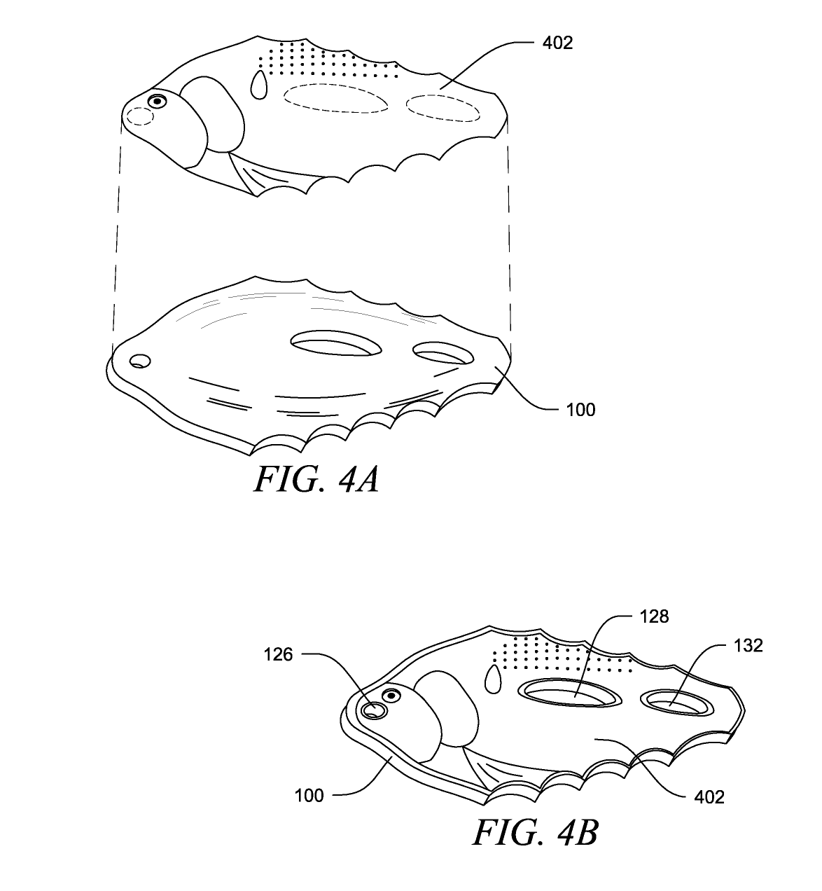

Fishing lure 10 can be further decorated by application of decals 402. An example decal is shown in FIGS. 4A and 4B. Decals 402 are preferably configured to substantially conform to one or both sides of lure body 100. Decals 402 can be decorated to resemble a fish or other bait. Alternatively, Decals 402 can include names, logos, or other insignia of companies, schools, sports teams, or the like.

Decals 402 preferably comprise a material which is easily applied to lure body 100 and will remain attached when submersed in water. Most preferably, decals 402 are removable, so that a user can replace one decal 402 with another decal 402. Alternatively, a user can place one decal 402 over an existing decal 402 or a user can place a decal 402 bait fish on the concave side of lure body 100 or a decal 402 color pattern on the convex side of lure body 100.

Decals 402 can be pre-applied to fishing lure 10 before retail sale, sold in a package with fishing lure 10, or sold separately. Decals 402 are preferably pre-cut to generally conform to the dimensions of lure body 100.

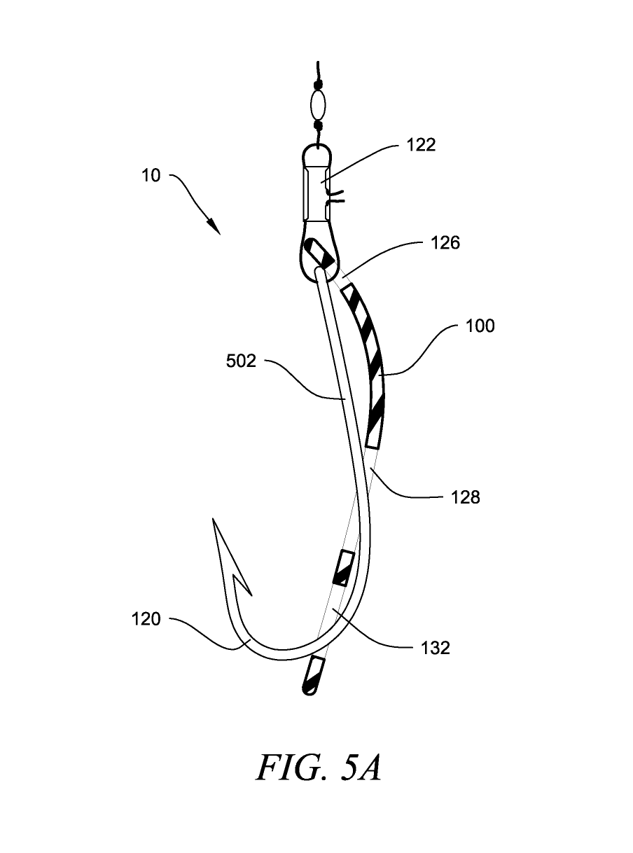

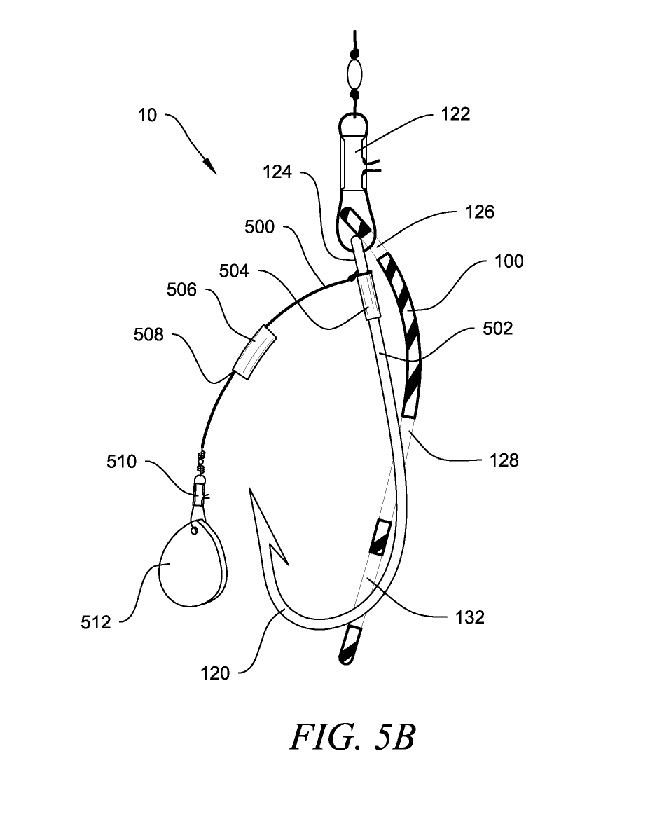

FIG. 5A is a section view of lure body 100 with hook 120. As illustrated, forward slot 128 is preferably longer than trailing slot 132 and positioned so that, when hook 120 is attached to hole 126, a bottom of the straight portion 502 of hook 120 will pass through forward slot 128.

FIG. 5B is a section view of lure body 100 with an optional weed guard 500. Weed guard 500 is attached to hook 120 by a sleeve 504 placed on hook 120. Weed guard 500 is preferably soldered or welded to sleeve 504. Sleeve 504 is preferably soldered or welded to shaft 502 just beneath hook eye 124.

A rattle chamber 506 is attached to weed guard 500. Rattle chamber 506 is made of plastic and contains plastic or metallic beads enclosed in a water proof chamber so they will create either a low or high pitch rattle when user retrieves lure body 100 through the water, rattle chamber 506 also acts as a fish attractor and can be offered to the user in various sound pitches and various color patterns.

A “Colorado style” spinner blade 512 is attached to distal end of weed guard 500. Spinner blade 512 is a fish enhancer/attractor accessory. Spinner blade 512 is available in a wide variety of styles/colors and can be sold separately. Spinner blade 512 is attached to weed guard 500 via swivel 510. Swivel 510 allows spinner blade 512 to spin and twist freely causing an erratic motion. Swivel 510 also allows a user to change to a different style or color spinner blade 512.

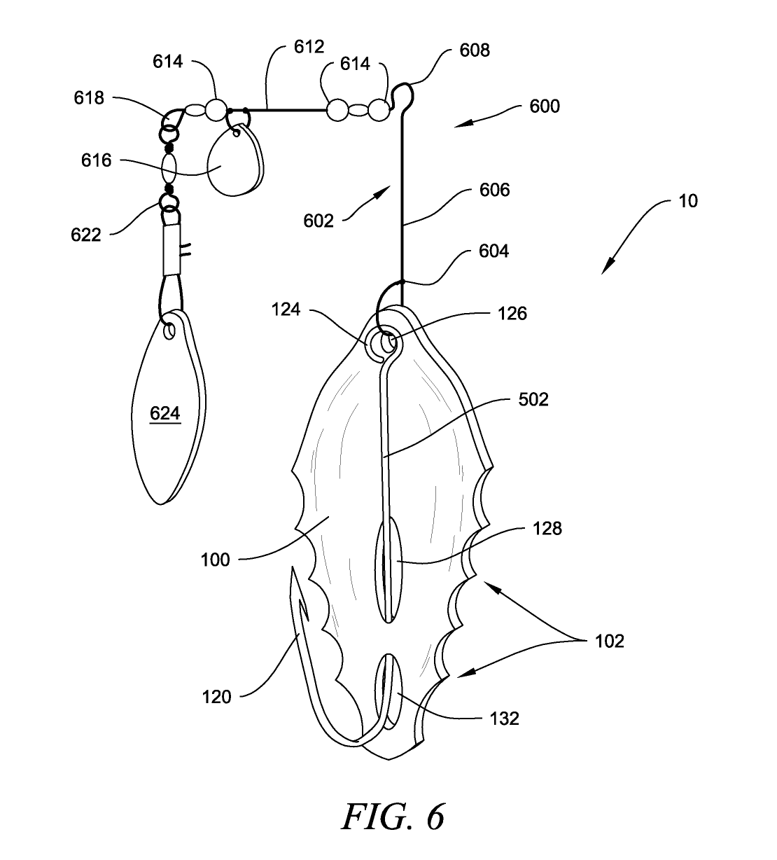

FIG. 6 illustrates fishing lure 10 attached to a spinner-bait attachment 600. Spinner-bait attachment 600 comprises wire 602. At one end of wire 602 is attachment loop 604, which is configured to engage eye 124 and/or hole 126. A first segment 606 extends from loop 604. A bend 608 is defined in wire 602 and is preferably configured to facilitate attachment of spinner-bait attachment 600 to a swivel hook (not shown) or other device connected to a fishing line. A second segment 612 extends from bend 608 preferably at an angle of about 90 degrees with respect to first segment 606. Second segment 612 is shown adorned with beads 614 and a first spinner blade 616. At a distal end of wire 602 from attachment loop 604 is ring 618. Attached to ring 618 is spinner swivel 622 and second spinner blade 624. Spinner-bait attachment 600 and its visual features such as beads 614 and spinner blades are preferably configured to attract fish to fishing lure 10.

Although the invention has been described with reference to specific embodiments, this description is not meant to be construed in a limiting sense. Various modifications of the disclosed embodiments, as well as alternative embodiments of the inventions, will be apparent to persons skilled in the art upon reference to the description of the invention. It is, therefore, contemplated that the appended claims will cover such modifications that fall within the scope of the invention.

What is claimed is:

1. A fishing lure comprising:
a lure body comprising a concave surface;
a first slot defined in the lure body;
a second slot defined in the lure body, wherein the first slot and the second slot are configured so that, when a fishing hook is placed through both of them, the fishing hook will be held in a position with the barb extending from the lure body.

2. The fishing lure of claim 1 wherein the lure body is a generally elliptical shape.

3. The fishing lure of claim 1 further comprising a hole defined near an end of the lure body, the hole configured so that a fishing hook can be attached to the lure body by affixing a attachment device through the hold and a fishing hook.

4. The fishing lure of claim 1 further comprising serrations defined in at least a portion of an edge of the lure body.

5. The fishing lure of claim 1 further comprising a fishing hook, wherein the fishing hook is positioned so that it extends through the first slot and the second slot.

6. The fishing lure of claim 5 further comprising a trailing hook attached to the fishing hook.

7. The fishing lure of claim 6 further comprising a retaining ring, positioned on the fishing hook and configured to hinder the trailing hook from detaching from the fishing hook.

8. The fishing lure of claim 1 further comprising a decal affixed to a surface of the lure body.

9. The fishing lure of claim 8 wherein the decal is configured to resemble a bait fish.

10. The fishing lure of claim 8 wherein the decal is removable.

11. The fishing lure of claim 1 further comprising a buzz blade attached to the lure body.

12. The fishing lure of claim 5 wherein the fishing hook is decorated with a skirt.

13. The fishing lure of claim 6 wherein the trailing hook is at least partially covered by an artificial bait.

14. A fishing lure assembly comprising:
a spinner blade attachment assembly comprising a wire, a fishing-line engagement bend defined in the wire, a lure-body segment of the wire extending from the fishing-line engagement bend with a lure body loop defined in the lure-body segment, and a spinner blade segment of the wire also extending from the fishing-line engagement bend;
one or more spinner blades attached to the spinner blade segment; and
a lure body attached to the lure-body segment, the lure body comprising a spoon-shaped plate with a hole defined near an edge, a forward slot and a rearward slot, wherein the forward slot and rearward slot are configured to receive a fishing hook and to maintain the fishing hook within a certain range of orientation with respect to the spoon-shaped plate.

15. The fishing lure of claim 14 wherein a fishing hook placed through the forward slot and the rearward is held at an orientation between 80 and 100 degrees with respect to a line tangent the spoon-shaped plate at a location between the forward slot and the rearward slot.

16. The fishing lure of claim 14 wherein the lure body is generally elliptical.

17. The fishing lure of claim 14 further comprising a decal affixed to a surface of the lure body.
